(19) United States
(12) Patent Application Publication
(10) Pub. No.: US 2020/0161974 A1
(43) Pub. Date: May 21, 2020

(54) CURRENT CONTROL SYSTEM, FUEL CELL SYSTEM, AND METHOD OF CONTROLLING BOOST CONVERTER

(71) Applicant: TOYOTA JIDOSHA KABUSHIKI KAISHA, Toyota-shi (JP)

(72) Inventor: Yutaka TANO, Toyota-shi (JP)

(73) Assignee: TOYOTA JIDOSHA KABUSHIKI KAISHA, Toyota-shi (JP)

(21) Appl. No.: 16/678,266

(22) Filed: Nov. 8, 2019

(30) Foreign Application Priority Data
Nov. 20, 2018 (JP) 2018-217210

(51) Int. Cl. H02M 3/158; H01M 8/04858

(52) U.S. Cl. CPC H02M 3/158; H01M 8/04873; H01M 8/04902

(57) ABSTRACT

A current control system includes a boost converter, and a converter controller that selectively performs control in a continuous mode using a calculated duty ratio for the continuous mode and control in a discontinuous mode using a calculated duty ratio for the discontinuous mode. The converter controller performs, at least in calculation of the duty ratio for the continuous mode, rising speed adjustment processing for adjusting a parameter used for the calculation of the duty ratio so that a rising amount of the duty ratio is restricted relative to the duty ratio used in a last cycle in accordance with a predetermined limit value, so as to restrict a rising speed of the duty ratio for the continuous mode more than a rising speed of the duty ratio for the discontinuous mode.

### CROSS-REFERENCE TO RELATED APPLICATION

The present application claims priority based on Japanese Patent Application No. 2018-217210, filed Nov. 20, 2018, the disclosure of which is hereby incorporated by reference herein in its entirety.

### BACKGROUND

### Field

The current disclosure relates to a current control system, a fuel cell system, and a method of controlling a boost converter.

### Related Art

For example, JP2015-019448A discloses a fuel cell system including a current control system in which a boost converter boosts an output voltage of a fuel cell. The operation of the boost converter is normally controlled by setting a duty ratio that defines a proportion of a period for accumulating electric energy in a cycle for repeatedly accumulating and discharging electric energy into and from a reactor. In such a current control system using such a boost converter, a duty ratio for a continuous mode and a duty ratio for a discontinuous mode are calculated, and one of them may be selected and used in accordance with predetermined conditions, such as in the current control system disclosed in JP2015-019448A. The continuous mode is a drive mode with a relatively-high target effective current in which a current larger than zero continuously flows in a reactor during one cycle. The discontinuous mode is a drive mode with a relatively-low target effective current in which once cycle includes a period where a current output from a reactor is zero.

A variation amount of an output current of a boost converter relative to a rising amount of a duty ratio is normally larger in the continuous mode than in the discontinuous mode. Thus, in the continuous mode, a slight deviation in a calculation result of a duty ratio, for example, may cause output of un unexpected excessively larger current than a necessary current from a boost converter.

### SUMMARY

According to one aspect of this disclosure, there is provided a current control system. The current control system of this aspect includes a boost converter that includes a reactor and repeats one cycle of operation for accumulating and discharging electric energy into and from the reactor so as to boost an input voltage, and a converter controller that is configured to calculate a duty ratio defining a proportion of a period for inputting and accumulating the energy into the reactor in one cycle, so as to control boost operation of the boost converter using the duty ratio, the converter controller is configured to selectively perform control in a continuous mode using a duty ratio for the continuous mode in which a current larger than zero continuously flows in the reactor in one cycle or control in a discontinuous mode using a duty ratio for the discontinuous mode in which one cycle includes a period with a current output from the reactor being zero. The converter controller is configured to perform, at least in calculation of the duty ratio for the continuous mode, rising speed adjustment processing for adjusting a parameter used for the calculation of the duty ratio so that a rising amount of the duty ratio calculated in a current cycle is restricted relative to the duty ratio used in a last cycle in accordance with a predetermined limit value, so as to restrict a rising speed of the duty ratio for the continuous mode more than a rising speed of the duty ratio for the discontinuous mode.

### BRIEF DESCRIPTION OF THE DRAWINGS

FIG. 1 is a schematic diagram of a fuel cell system including a current control system;

FIG. 2 is a schematic diagram illustrating a configuration of a boost converter;

FIG. 3A is an explanatory diagram illustrating a temporal change of a reactor current in a continuous mode;

FIG. 3B is an explanatory diagram illustrating a temporal change of a reactor current in a discontinuous mode;

FIG. 4 is an explanatory diagram exemplifying the tendency of the relation between a duty ratio and an output current of a boost converter;

FIG. 5 is an explanatory diagram illustrating a flow of boost control according to a first embodiment;

FIG. 6 is an explanatory diagram illustrating a flow of rising speed adjustment processing according to the first embodiment; and

FIG. 7 is an explanatory diagram illustrating a flow of rising speed adjustment processing according to a second embodiment.

### DETAILED DESCRIPTION

### 1. First Embodiment

1-1. Overview of Current Control System and Fuel Cell System:

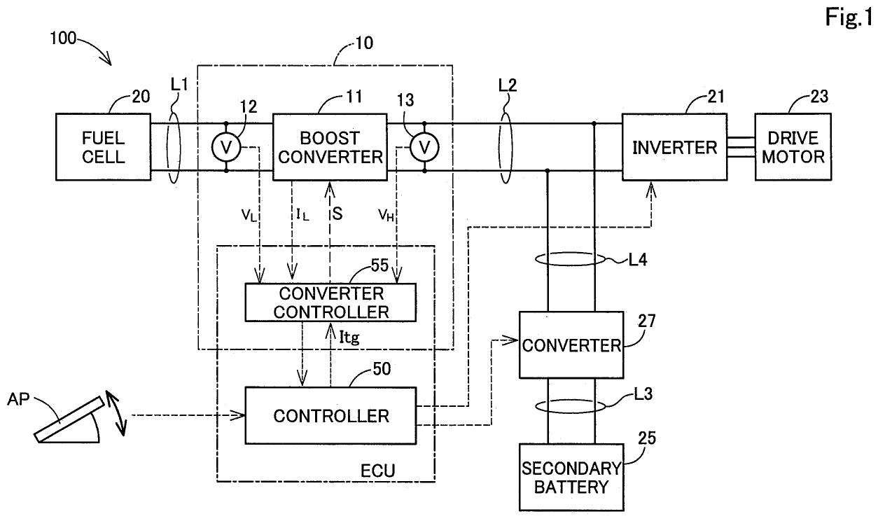

FIG. 1 is a schematic diagram illustrating an electrical configuration of a fuel cell system 100 including a current control system 10 according to the first embodiment. The current control system 10 includes a boost converter 11, and the boost converter 11 boosts an output voltage of a fuel cell 20 of the fuel cell system 100 so as to control an output current of the fuel cell 20. The fuel cell system 100 is provided in a fuel cell vehicle, and controls the fuel cell 20 to generate power in accordance with a driver's request received through an accelerator pedal AP or a request generated internally by automatic control and the like. The following will describe the configuration of the fuel cell system 100 except for the current control system 10 and then the configuration of the current control system 10.
1-2. Configuration of Fuel Cell System except for Current Control System

The fuel cell 20 is a polymer electrolyte fuel cell that generates power with receiving the supply of hydrogen and oxygen as reaction gas. The fuel cell 20 is not limited to a polymer electrolyte fuel cell. In other embodiments, various types of fuel cells may be adopted as the fuel cell 20. For example, a solid oxide fuel cell may be adopted as the fuel cell 20. The fuel cell 20 is connected to an input terminal of the boost converter 11 of the current control system 10 through a first DC wire L1.

The fuel cell system 100 includes, in addition to the fuel cell 20, an inverter 21 converting a DC into an AC, and a drive motor 23 generating drive power of a fuel cell vehicle. The inverter 21 is a DC/AC inverter. A DC terminal of the inverter 21 is connected to an output terminal of the boost converter 11 through a second DC wiring L2. A relay circuit may be provided between the inverter 21 and the boost converter 11. The drive motor 23 is a three-phase AC motor, and is connected to an AC terminal of the inverter 21 through an AC wiring. The inverter 21 converts a DC supplied through the second DC wiring L2 into a three-phase AC and supplies it to the drive motor 23. Moreover, the inverter 21 converts a regenerative current occurred in the drive motor 23 into a DC and outputs it to the second DC wiring L2.

External loads other than the drive motor 23 may be connected to the inverter 21. The fuel cell system 100 may include a plurality of inverters 21 connected to the second DC wiring L2. In this case, auxiliary machines, whose illustration thereof is omitted, other than the drive motor 23 and electric components of the fuel cell vehicle may be electrically connected to the second DC wiring L2 through the inverter 21.

The fuel cell system 100 further includes a secondary battery 25 and a converter 27. The secondary battery 25 is constituted by a lithium ion battery, for example. The secondary battery 25 stores a part of power generated by the fuel cell 20 and the above-described regenerative power. The secondary battery 25 functions as a power source of the fuel cell system 100 together with the fuel cell 20 by discharging the stored power. The secondary battery 25 is connected to an input terminal of the second battery converter 27 through a third DC wiring L3.

The converter 27 is a boosting-type converter device. An output terminal of the converter 27 is connected, through a fourth DC wiring L4, to the second DC wiring L2 connecting the boost converter 11 and the inverter 21. Under the control of a controller 50, the secondary battery 27 cooperates with the boost converter 11 of the current control system 10 to adjust a voltage in the second DC wiring L2 that is an input voltage of the inverter 21 and control charge and discharge of the secondary battery 25. If the output power from the boost converter 11 is insufficient for target output power, the converter 27 controls the secondary battery 25 to discharge power. While, if regenerative power is occurred in the drive motor 23, the converter 27 stores the regenerative power in the secondary battery 25.

The fuel cell system 100 includes the controller 50 controlling the entire of the fuel cell system 100. The controller 50 is constituted by an electronic controller, which is also called as ECU, including at least one processor and a main storage device. The controller 50 executes programs and instructions read onto the main storage device by the processor and thus exerts various functions for controlling power generation of the fuel cell 20. At least a part of the functions of the controller 50 may be configured by a hardware circuit.

The controller 50 is configured to control operation of the fuel cell 20 in accordance with target output power demanded for the fuel cell system 100. To be more specific, the controller 50 is configured to control a supply amount and a supply pressure of reaction gas to the fuel cell 20. The controller 50 is configured to function as an upper controller of a converter controller 55, which is described later, of the current control system 10, and is configured to control output power of the fuel cell 20 and input power to the inverter 21. To be more specific, the controller 50 is configured to input a target output current Itg of the boost converter 11 to the converter controller 55. Furthermore, the controller 50 is configured to acquire measurement results of an output voltage of the fuel cell 20 and an output current of the boost converter 11 from the converter controller 55 and uses them for operation control of the fuel cell 20. In addition, the controller 50 is configured to control the converter 27 to control output power from the secondary battery 25. Moreover, the controller 50 is configured to control the AC magnitude output by the inverter 21 in accordance with an opening of an accelerator pedal AP by a driver.
1-3. Configuration of Current Control System:

In the current control system 10, the boost converter 11 boosts an input voltage input from the fuel cell 20 through the first DC wiring L1 in accordance with the target output current Itg of the boost converter 11, and controls an output current of the fuel cell 20. The boost converter 11 may be constituted by using an intelligent power module, which is also called as IPM, for example. The detailed configuration of the boost converter 11 and the control method thereof will be described later.

The current control system 10 includes, in addition to the boost converter 11, an input voltage measurement unit 12, an output voltage measurement unit 13, and the converter controller 55. Each of the two voltage measurement units 12, 13 is constituted by a voltage sensor, for example. The input voltage measurement unit 12 connected to the first DC wiring L1 measures an input voltage V_{L} to the boost converter 11, and outputs the measurement result to the converter controller 55. The output voltage measurement unit 13 connected to the second DC wiring L2 measures an output voltage V_{H} of the boost converter 11, and outputs the measurement result to the converter controller 55.

The converter controller 55 is constituted by a computer including at least one processor and a main storage device. In the first embodiment, the converter controller 55 is constituted as a part of the ECU constituting the controller 50. The converter controller 55 is configured to execute programs and instructions read onto the main storage device by the processor and thus exerts various functions for controlling boosting operation of the boost converter 11. At least a part of the functions of the converter controller 55 may be configured by a hardware circuit. In another embodiment, the converter controller 55 may be constituted as a separate unit from the controller 50.

The converter controller 55 is configured to calculate a duty ratio in accordance with a target input current of the boost converter 11 for achieving the target output current Itg, and drives the boost converter 11 at the duty ratio to perform boost control for controlling an input current of the boost converter 11. The converter controller 55 is configured to transmit control signals S for driving the boost converter 11 at the calculated duty ratio to the boost converter 11. The converter controller 55 is configured to use the input voltage V_{L} and the output voltage Vx input from the input voltage measurement unit 12 and the output voltage measurement unit 13 to calculate a duty ratio. Moreover, the converter controller 55 is configured to receive the reactor current I_{L} measured by a current measurement unit, which is described later, of the boost converter 11 through a signal line, and is configured to use it to calculate a duty ratio. The details of the duty ratio will be described later.
1-4. Configuration of Boost Converter:

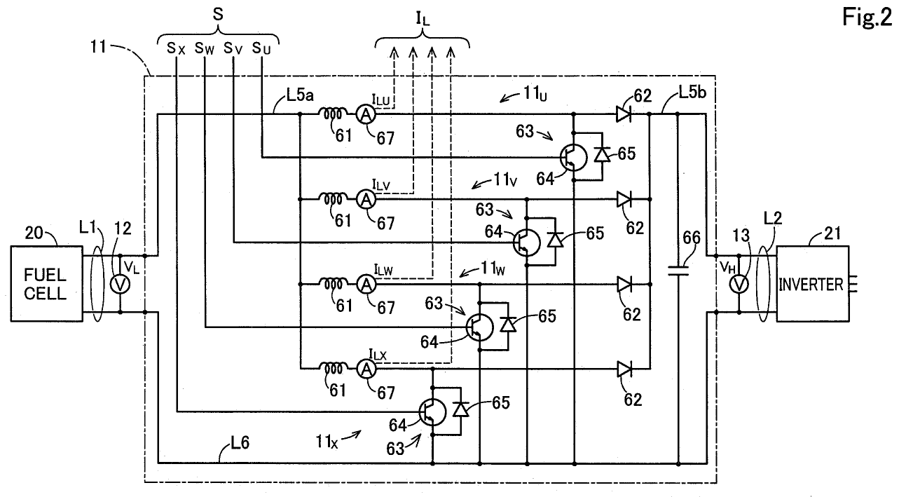

FIG. 2 is a schematic diagram illustrating a configuration of the boost converter 11. The boost converter 11 is configured as a four-phase bridge converter, and includes a U-phase circuit part 11_{U}, a V-phase circuit part 11_{V}, a W-phase circuit part 11_{W}, and an X-phase circuit part 11_{X}. In the following description, U, V, W, and X added to the end of the reference symbols indicate correspondence to the phase circuit parts 11_{U}, 11_{V}, 11_{W}, 11_{X}, respectively.

The phase circuit parts 11_{U}, 11_{V}, 11_{W}, 11_{X} are connected to a first and second power lines L5a, L5b, and an earth line L6. The first power line L5a is a power line on the input side connected to the fuel cell 20, and the second power line L5b is a power line on the output side connected to the inverter 21. The earth line L6 applies reference potential to the fuel cell 20 and the inverter 21 in common.

Each of the phase circuit parts 11_{U}, 11_{V}, 11_{W}, 11_{X} includes a reactor 61, an output diode 62, and a switching element 63. The reactor 61 is an element for storing electric energy. An input terminal of the reactor 61 is connected to the first power line L5a. An output terminal of the reactor 61 is connected to the second power line L5b through the diode 62, and connected to the earth line L6 through the switching element 63.

The diode 62 is provided with a direction from the reactor 61 toward the second power line L5b as a forward direction. The diode 62 restricts a current flow from the second power line L5b toward the reactor 61.

The switching element 63 includes a transistor 64 and a protection diode 65. The transistor 64 is an npn-type transistor, and is constituted by an insulated gate bipolar transistor which is also called as IGBT, a power metal oxide semiconductor transistor which is also called as MOS transistor, a power bipolar transistor, or the like, for example. The transistor 64 is connected with the reactor 61 side as a collector and the earth line L6 side as an emitter. The protection diode 65 is connected between the collector and the emitter of the transistor 64 in a reverse direction to a direction in which a collector current flows.

The control signals S transmitted from the converter controller 55 to the boost converter 11 include control signals S_{U}, S_{V}, S_{W}, S_{X} for the phase circuit parts 11_{U}, 11_{V}, 11_{W}, 11_{X}. One corresponding signal among the control signals S_{U}, S_{V}, S_{W}, S_{X} is input to a base terminal of the transistor 64 of the phase circuit parts 11_{U}, 11_{V}, 11_{W}, 11_{X}. The switching element 63 of the phase circuit parts 11_{U}, 11_{V}, 11_{W}, 11_{X} is repeatedly turned on and turn off in accordance with the control signals S_{U}, S_{V}, S_{W}, S_{X} input thereto.

In the first embodiment, a current measurement unit 67 is provided on the output side of the reactor 61 of each of the phase circuit parts 11_{U}, 11_{V}, 11_{W}, 11_{X}. The current measurement unit 67 is constituted by a current sensor, for example. The current measurement unit 67 transmits a measurement result of reactor currents I_{LU}, I_{LV}, I_{LW}, I_{LX} that are currents flowing in the reactor 61 of the corresponding phase circuit parts 11_{U}, 11_{V}, 11_{W}, 11_{X} to the controller 50. In the specification, the reactor current I_{LU}, I_{LV}, I_{LW}, I_{LX} are referred to collectively as a “reactor current I_{L}” unless it is necessary to distinguish them from one another. The reactor current I_{L} is periodically increased and reduced by on-off operation of the switching element.

A smoothing capacitor 66 is provided on the output terminal side than the phase circuit parts 11_{U}, 11_{V}, 11_{W}, 11_{X}. The smoothing capacitor 66 is connected to the second power source line L5b and the earth line L6. The smoothing capacitor 66 has a function of reducing voltage variation between the second power source line L5b and the earth line L6.
1-5. Boosting Operation of Boost Converter and Duty Ratio:

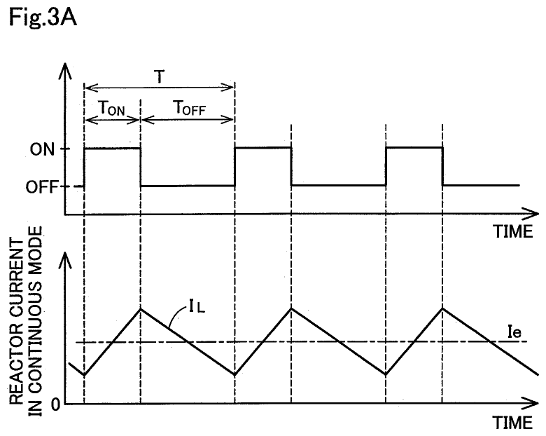

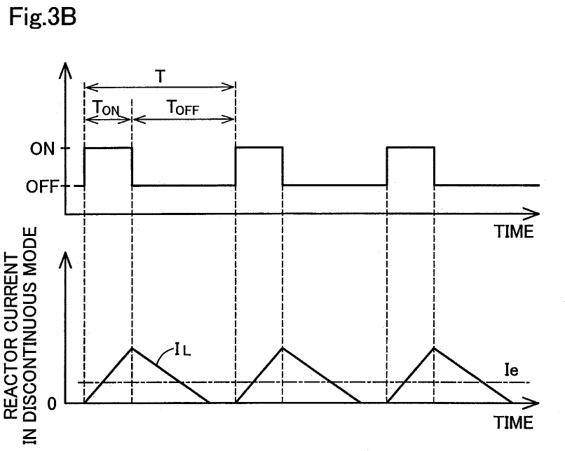

Referring with FIG. 3A, the duty ratio for driving the boost converter 11 will be described here. FIG. 3A illustrates an example of a timing chart illustrating the on/off timing of the switching element 63 and the temporal change of the reactor current I_{L}.

Once the switching element 63 is turned on, a current starts to flow into the switching element 63 from the fuel cell 20 through the reactor 61, so that the reactor current I_{L} is increased. Meanwhile, magnetic energy by DC excitation is accumulated in the reactor 61. Once the switching element 63 is turned off, the reactor current I_{L} starts to be reduced gradually. The reactor current I_{L} at that time is generated by discharge of magnetic energy accumulated in the reactor 61 during a period in which the switching element 63 is on.

An output voltage of the fuel cell 20 is overlapped by an induced voltage occurred by discharge of magnetic energy accumulated in the reactor 61 when the switching element 63 is turned off. The timing of turn-on of the switching element 63 of each of the phase circuit parts 11_{U}, 11_{V}, 11_{W}, 11_{X} deviates with a predetermined interval, and an output voltage of the fuel cell 20 is sequentially overlapped by an output voltage of the phase circuit parts 11_{U}, 11_{V}, 11_{W}, 11_{X}. In this manner, the output voltage of the fuel cell 20 is boosted and then input to the inverter 21.

As described above, the boost converter 11 performs boosting by repeating one cycle of operation for accumulating and discharging electric energy into and from the reactor 61. During one cycle of such boosting operation, the duty ratio defines a proportion of a period in which the switching element 63 is opened and electric energy is accumulated into the reactor 61. When defining one cycle period of boosting operation by the boost converter 11 as T, a period in which the switching element 63 is on as T_{ON}, and a period in which the switching element 63 is off as T_{OFF}, the duty ratio D is expressed by D=T_{ON}/T.

In the current control system 10, the converter controller 55 is configured to set the duty ratio D for each of the phase circuit parts 11_{U} to 11_{X} for each cycle, so as to control an output current Ie of the boost converter 11. Note that the duty ratio may be set for every plurality of cycles such as two to five cycles, for example. The output current Ie of the boost converter 11 corresponds to an effective current found by a time average of the reactor current I_{L}. When the duty ratio D is increased, the proportion of the turn-on period T_{ON} of the switching element 63 becomes large in one cycle period T. This increases electric energy accumulated in the reactor 61, and thus increases the output current Ie of the boost converter 11. When the duty ratio D is lowered, the proportion of the turn-on period T_{ON} of the switching element 63 becomes small in one cycle period T. This reduces electric energy accumulated in the reactor 61, and thus reduces the output current Ie of the boost converter 11.

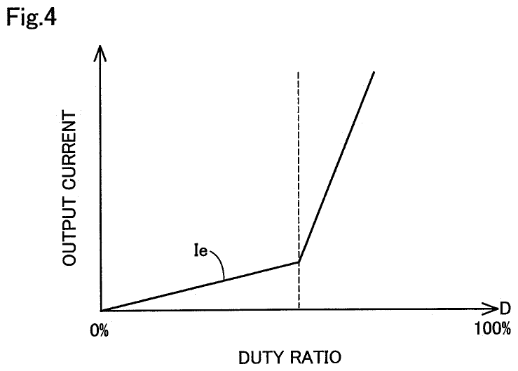

Referring with FIG. 3A, FIG. 3B and then FIG. 4, the drive mode of the boost converter 11 will be described here. The temporal change of the reactor current I_{L} illustrated in FIG. 3A is an example of the case of the continuous mode. FIG. 3B illustrates an example of temporal change of the reactor current I_{L} in the discontinuous mode. The drive mode of the boost converter 11 includes a continuous mode and a discontinuous mode. The continuous mode is a drive mode in which a current larger than zero continuously flows in the reactor 61 during one cycle of boosting operation by the boost converter 11. The discontinuous mode is a drive mode in which one cycle of boosting operation by the boost converter 11 includes a period where a current output by the reactor 61 is zero.

FIG. 4 is an explanatory diagram exemplifying the tendency of the relation between the duty ratio D and the output current Ie of the boost converter 11. In a range where the duty ratio D is small, the boost converter 11 is in the discontinuous mode where the reactor current I_{L} is intermittently zero. Thus, the output current Ie of the boost converter 11 only increases relatively gently relative to the increase of the duty ratio D.

On the other hand, in a range where the duty ratio D is large, the reactor current I_{L} is constantly larger than zero. Thus, the output current Ie of the boost converter 11 increases relatively abruptly relative to the increase of the duty ratio D. In this manner, the increase amount of the output current Ie relative to the rising amount of the duty ratio D is considerably larger in the continuous mode than in the discontinuous mode.

In the current control system 10, the duty ratio D is calculated by different numerical expressions based on the characteristics of each of the discontinuous mode and the continuous mode. In the following, the duty ratio D found by a numeral expression reflecting the characteristics of the continuous mode is referred to as a “duty ratio D for the continuous mode”, while the duty ratio D found by a numeral expression reflecting the characteristics of the discontinuous mode is referred to as a “duty ratio D for the discontinuous mode”.

In the boost control of the current control system 10 described in the following, the duty ratios D for both modes are calculated for each cycle of the boosting operation, and one of the modes is used selectively so as to appropriately switch the continuous mode and the discontinuous mode. Moreover, in the boost control, there is performed boosting speed adjustment processing for preventing excessive increase of a rising speed of the duty ratio D in order to prevent the abrupt increase of an output current of the boost converter 11.
1-6. Boost Control:

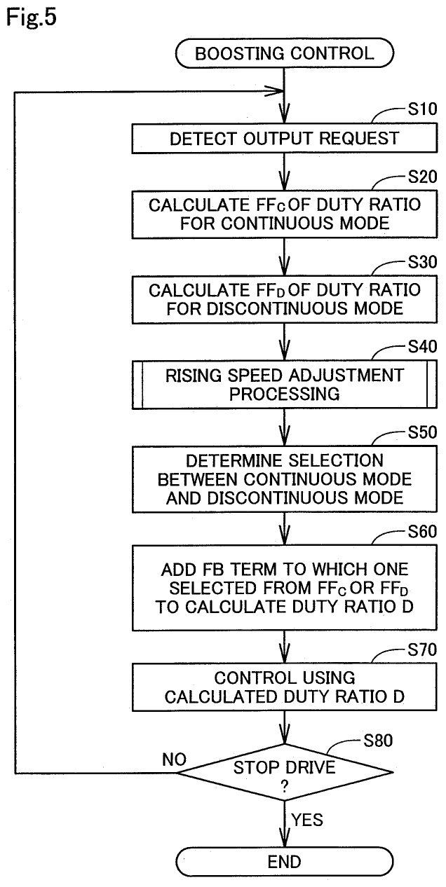

FIG. 5 is an explanatory diagram illustrating a flow of boost control of the first embodiment performed by the converter controller 55. Once the fuel cell system 100 is started and the fuel cell 20 starts to generate power, the converter controller 55 starts the boost control. At Step S10, the converter controller 55 detects an output request to the current control system 10. To be more specific, the converter controller 55 detects the target output current Itg of the boost converter 11 input by the controller 50.

The subsequent steps S20 to S60 are steps for calculating a duty ratio D. The duty ratio D is calculated using a feedforward term that is a parameter reflecting the target output of the boost converter 11. In the first embodiment, to calculate the duty ratio D, a feedback term that is a parameter reflecting a current output of the boost converter 11 is added to the above-described feedforward term. Note that the duty ratio D is calculated for each of the phase circuit parts 11_{U}, 11_{V}, 11_{W}, 11_{X}.

At Step S20, the converter controller 55 calculates a feedforward term FF_{C} for the continuous mode that is used for calculation of the duty ratio D for the continuous mode. The converter controller 55 calculates the feedforward term FF_{C} using the current input voltage V_{L} and the output voltage V_{H}. The converter controller 55 calculates the feedforward term FF_{C} by the following numerical expression (1), for example.

$$[ Math . 1 ]$$

$${FF}_{C} = 1 - \frac{{V}_{L}}{{V}_{H}} \qquad ( 1 )$$

At Step S30, the converter controller 55 calculates a feedforward term FF_{D} for the discontinuous mode that is used for calculation of the duty ratio D for the discontinuous mode. The converter controller 55 calculates the feedforward term FF_{D} using the input voltage V_{L}, the output voltage V_{H}, and a target phase current Ie_{T}. The target phase current Ie_{T} is a command value of an effective current that is found using the target output current Itg and output for each of the phase circuit parts 11_{U}, 11_{V}, 11_{W}, 11_{X}. The converter controller 55 calculates the feedforward term FF_{D} by the following numerical expression (2), for example. L in the numerical expression (2) is an inductance of the reactor 61 and f is a frequency of the boost converter 11.

$$[ Math . 2 ]$$

$${FF}_{D} = \sqrt{2 \times L \times f} \times \sqrt{\frac{{V}_{H} - {V}_{L}}{{V}_{H} \times {V}_{L}}} \times \sqrt{{Ie}_{T}} \qquad ( 2 )$$

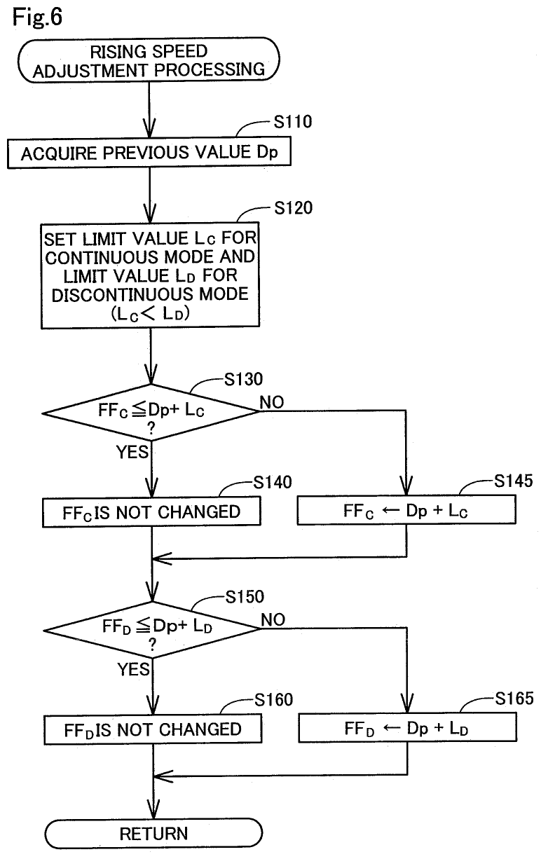

Referring with FIG. 6, the rising speed adjustment processing of the first embodiment performed by the converter controller 55 at Step S40 will be described here. FIG. 6 is an explanatory diagram illustrating a flow of the rising speed adjustment processing. In the rising speed adjustment processing, a rising amount of the duty ratio D in the current cycle relative to the duty ratio D used in the last cycle is restricted in accordance with limit, values L_{C}, L_{D} described later to prevent abrupt increase of the rising speed of the duty ratio D. The rising speed of the duty ratio D indicates a rising amount of the duty ratio D per unit time. In the current control system 10, the rising speed adjustment processing restricts the rising speed of the duty ratio D for the continuous mode more than the rising speed of the duty ratio D for the discontinuous mode. Note that the rising speed adjustment processing at Step S40 may be omitted if the target output current Itg of the boost converter 11 is lowered as compared with the last cycle.

At Step S110, the converter controller 55 acquires the duty ratio D used for driving the boost converter 11 in the last cycle as a previous value Dp. To be more specific, the converter controller 55 reads out the duty ratio D in the last cycle stored in a storage unit which is not illustrated in the figures, in the previous cycle, and substitutes such a duty ratio D in the previous value Dp that is a variable.

At Step S120, the converter controller 55 acquires the predetermined limit value L_{C} for the continuous mode and limit value L_{D} for the discontinuous mode. The converter controller 55 reads out the limit values L_{C}, L_{D} preliminarily stored in the storage unit which is not illustrated in the figures. In the first embodiment, the limit value L_{C} for the continuous mode is smaller than the limit value L_{D} for the discontinuous mode. In this manner, the limit values L_{C}, L_{D} of the modes are different from each other. The reason thereof will be described later.

At Step S130, the converter controller 55 determines the feedforward term FF_{C} for the continuous mode that is calculated at Step S20 of FIG. 5. The converter controller 55 determines whether the rising amount of the feedforward term FF_{C} for the continuous mode relative to the previous value Dp, that is, a value resulted by subtracting the previous value Dp from the feedforward term FF_{C} for the continuous mode is equal to or smaller than the limit value L_{C} for the continuous mode.

When the rising amount does not exceed the limit value L_{C} and the relation FF_{C}-Dp≤L_{C}, that is, FF_{C}≤Dp+L_{C} is fulfilled, the converter controller 55 determines at Step S140 that the feedforward term FF_{C} is not to be changed. When the rising amount exceeds the limit value L_{C} and the relation FF_{C}-Dp≤L_{C} is not fulfilled, the converter controller 55 sets again a value resulted by adding the limit value L_{C} to the previous value Dp as the feedforward term FF_{C} at Step S145.

At Step S150, the converter controller 55 determines the feedforward term FF_{D} for the discontinuous mode that is calculated at Step S30 of FIG. 5. The converter controller 55 determines whether the rising amount of the feedforward term FF_{D} for the discontinuous mode relative to the previous value Dp, that is, a value resulted by subtracting the previous value Dp from the feedforward term FF_{D} for the discontinuous mode is equal to or smaller than the limit value L_{D} for the discontinuous mode.

When the rising amount does not exceed the limit value L_{D} and the relation FF_{D}-Dp≤L_{D}, that is, FF_{D}≤Dp+L_{D} is fulfilled, the converter controller 55 determines at Step S160 that the feedforward term FF_{D} is not to be changed. When the rising amount exceeds the limit value L_{D} and the relation FF_{D}-Dp≤L_{D} is not fulfilled, the converter controller 55 sets again a value resulted by adding the limit value L_{D} to the previous value Dp as the feedforward term FF_{D}at Step 165. In this manner, the limit values L_{C}, L_{D} indicate upper limit values of the rising amount in each cycle of the feedforward terms FF_{C}, FF_{D} that are parameters for calculating the duty ratio D. That is, it is understood that the limit values L_{C}, L_{D} indicate upper limit values of the rising speed of the feedforward terms FF_{C}, FF_{D} per unit time.

FIG. 5 is referred to. At Step S50, the converter controller 55 determines which of the continuous mode and the discontinuous mode is to be selected for the control. To be more specific, the converter controller 55 determines which of the two calculated feedforward terms FF_{C}, FF_{D} is to be used in the current cycle, on the basis of the predetermined determination conditions. In the first embodiment, the converter controller 55 selects a smaller feedforward term of the two feedforward terms FF_{C}, FF_{D} as a parameter for calculating the duty ratio D used in the current cycle. Note that in other embodiments, the converter controller 55 may select the feedforward term FF_{C}, FF_{D} to be used on the basis of different determination conditions from the one described above. For example, the converter controller 55 may select the feedforward term FF_{C}, FF_{D} closer to a predetermined determination value.

At Step S60, the converter controller 55 adds the feedback term FB to which one selected from the feedforward term FF_{C} or FF_{D} to calculate the duty ratio D to be used in the current cycle. The feedback term FB is a parameter added to compensate a deviation of the output current Ie of the boost converter 11 relative to the target output current Itg. In the first embodiment, the feedback term FB is calculated using a difference between the target output current Itg and the output current Ie.

At Step S70, the converter controller 55 controls the boost converter 11 using the duty ratio D calculated at Step S60. Note that the control by duty ratio D calculated using the feedforward term Fc for the continuous mode is control in the continuous mode, while the control by the duty ratio D calculated using the feedforward term FF_{D} for the discontinuous mode is control in the discontinuous mode. In this manner, the converter controller 55 selectively performs control in the continuous mode and control in the discontinuous mode. The converter controller 55 stores the duty ratio D used in the current cycle to read out as the previous value Dp in the next cycle.

At Step S80, the converter controller 55 determines whether the controller 50 has output an order for stopping the drive of the boost converter 11. The converter controller 55 repeats the steps from Step S10 until the controller 50 outputs an order for stopping the drive of the boost converter 11. The converter controller 55 finishes boost control once the controller 50 has output an order for stopping the drive of the boost converter 11.

### 1-7. Summary of First Embodiment

As described above, in the current control system 10 of the first embodiment, the limit value L_{C} used for calculating the feedforward term Fc for the continuous mode is smaller than the limit value L_{D} used for calculating the feedforward term FF_{D} for the discontinuous mode in the rising speed adjustment processing. Thus, the rising speed of the duty ratio D for the continuous mode is greatly restricted more than the rising speed of the duty ratio D for the discontinuous mode. Therefore, in the continuous mode where the increase amount of the output current Ie relative to the variation amount of the duty ratio D is large, it is possible to prevent increase of the duty ratio D at an excessive rising speed and prevent output of an unexpectedly large current from the boost converter 11.

Moreover, in the current control system 10 of the first embodiment, the limit value L_{D} is set to a relatively small value, which prevents the rising speed of the duty ratio D for the discontinuous mode from being restricted largely. Therefore, it is possible to considerably increase the duty ratio D for the discontinuous mode and prevent, in the discontinuous mode, the case in which the demanded increase amount of the output current Ie of the boost converter 11 is not obtained. In addition, in the first embodiment, the rising speed adjustment processing restricts the rising speed of the duty ratio D for the continuous mode and the duty ratio D for the discontinuous mode, in accordance with the limit values L_{C}, L_{D}, respectively. Therefore, regardless of which of the continuous mode and the discontinuous mode is selected for the control, it is possible to prevent excessive increase of the rising speed of the duty ratio D so that an unexpectedly large current is output from the boost converter 11.

At Steps S145, S165 of rising speed adjustment processing of the first embodiment, the feedforward terms FF_{C}, FF_{D} that are parameters for calculating the duty ratio D are adjusted not to exceed the limit values L_{C}, L_{D}. The feedforward term FF_{C}, FF_{D} normally occupies a large proportion of the duty ratio D. Thus, the feedforward term FF_{C}, FF_{D} is adjusted not to exceed the limit value L_{C}, L_{D}, whereby it is possible to easily adjust a rising speed of the duty ratio D in accordance with the limit values L_{C}, L_{D}.

Especially in the rising speed adjustment processing of the first embodiment, when a difference between the previous value Dp and the feedforward term FF_{C}, FF_{D} is larger than the limit value L_{C}, L_{D}, the feedforward term FF_{C}, FF_{D} is set to a value resulted by adding the limit value L_{C}, L_{D} to the previous value Dp. In this manner, it is possible to set the feedforward term FF_{C}, FF_{D} to the maximum in an allowed range, which prevents the case in which the duty ratio D is set to an excessively small value by rising speed adjustment processing.

At Step S60 of boost control of the first embodiment, the feedback term FB is added to the feedforward term FF_{C}, FF_{D} adjusted by rising speed adjustment processing to calculate the duty ratio D. In this manner, it is possible to allow the feedback term FB to compensate, with high accuracy, a deviation between the output current Ie and the target output current Itg that is occurred by a measurement error of a current value and a voltage value, an individual difference of the reactor 61, and the like, without any restriction by the limit value L_{C}, L_{D} of rising speed adjustment processing. Therefore, it is possible to prevent a large deviation between the output current Ie and the target output current Itg while preventing excessive increase of the rising speed of the duty ratio D, and thus increase control accuracy of the output current of the boost converter 11. Moreover, the reduction of such a deviation between the output current Ie and the target output current Itg prevents torque shortage relative to the target torque of the drive motor 23. Therefore, it is possible to prevent a driver of a fuel cell vehicle from feeling so-called torque shock.

The fuel cell system 100 of the first embodiment includes the current control system 10, which prevents occurrence of an excessive large current in boosting the output voltage of the fuel cell 20. In addition, the current control system 10, the fuel cell system 100, and the method of controlling the boost converter 11 achieved by piezoelectric control according to the first embodiment exert various action effects described in the first embodiment.

### 2. Second Embodiment

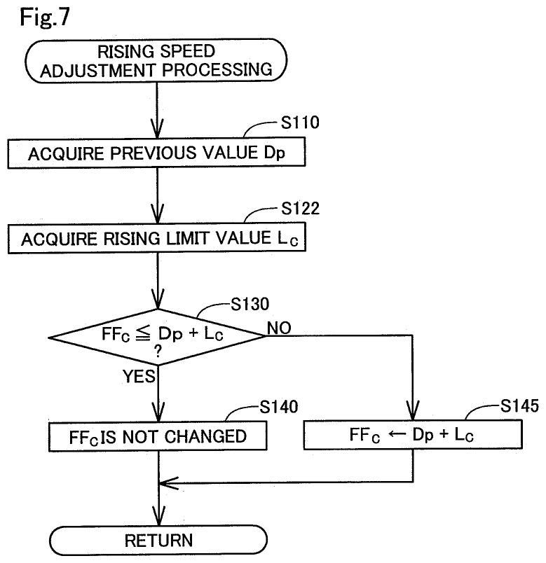

FIG. 7 is an explanatory diagram illustrating a flow of rising speed adjustment processing of the second embodiment. The rising speed adjustment processing of the second embodiment is performed by piezoelectric control of the same flow described in the first embodiment. The piezoelectric control of the second embodiment is performed by the current control system 10 having the same configuration as the first embodiment. The current control system 10 is provided in the fuel cell system 100 having the same configuration as the first embodiment.

The rising speed adjustment processing of the second embodiment is substantially same as the rising speed adjustment processing of the first embodiment except for the aspects that Step S120 is replaced by Step S122 for acquiring only a limit value L_{C} for the continuous mode and Steps S150 to S165 are omitted. The rising speed adjustment processing of the second embodiment is performed only when the duty ratio D for the continuous mode is calculated. In the second embodiment, the duty ratio D for the discontinuous mode is calculated without adjusting its rising speed.

In the piezoelectric control of the second embodiment, it is possible to restrict a rising speed of only the duty ratio D for the continuous mode. Therefore, similarly to the first embodiment, it is possible to prevent abrupt increase of the output current Ie of the boost converter 11 when the feedforward term FF_{C} for the continuous mode is selected and the duty ratio D is calculated. Moreover, the rising speed adjustment processing does not restrict a rising speed of the duty ratio D calculated using the feedforward term FF_{D} for the discontinuous mode. Thus, the duty ratio D for the discontinuous mode may be varied largely. This prevents, in the discontinuous mode, the case in which the target increase amount of the output current is not obtained. In addition, the current control system 10, the fuel cell system 100, and the method of controlling the boost converter 11 according to the second embodiment exert the same various action effects as the first embodiment.

### 3. Other Embodiments

The various configurations in the above-described embodiments may be modified in the following manners, for example. Any of other embodiments described in the following is regarded as an example of the embodiment of the disclosure, similarly to the above-described embodiments.

### Another Embodiment 1

In the above-described embodiments, there may be performed, in addition to the rising speed adjustment processing, processing of further correcting a calculated duty ratio D so that it does not exceed a predetermined upper limit value. If a calculated duty ratio D exceeds a predetermined upper limit value, for example, such correction processing may be processing of replacing a value of the calculated duty ratio D by the upper limited value.

### Another Embodiment 2

In the above-described embodiments, the feedforward terms FF_{C}, FF_{D} that are parameters for calculating the duty ratio D may be found by a numerical expression other than the above-described numerical expressions (1), (2). Moreover, in the calculation of the duty ratio D, the feedback term FB may not be added, or a parameter other than the feedback term FB may be added. The duty ratio D may be calculated without any numerical expression. The duty ratio D may be calculated using a map in which the relation equivalent to a numerical expression is set, for example. In a case where the duty ratio D is calculated using a parameter other than the feedforward terms FF_{C}, FF_{D}, the rising speed adjustment processing described in the above-described embodiments may be applied to such a parameter instead of the feedforward terms FF_{C}, FF_{D}. In the above-described embodiments, it is possible to calculate two duty ratios D for the continuous mode and for the discontinuous mode using the feedforward terms FF_{C}, FF_{D}, and then select which duty ratio D is to be used may be selected.

### Another Embodiment 3

In the rising speed adjustment processing, the parameter for calculating the duty ratio D may be adjusted by a method other than the methods described in the above-described embodiments. For example, when a parameter for calculating the duty ratio D of the feedforward term FF_{C}, FF_{D} or the like exceeds a limit value, the parameter may be multiplied by a predetermined ratio to be a small value. Alternatively, when the calculated duty ratio D exceeds a limit value, a value uniquely determined for the limit value may be subtracted from such a duty ratio D.

### Another Embodiment 4

The boost converter 11 is not limited to a four-phase converter. The boost converter 11 may be formed by a two-phase or a three-phase converter, or may be formed by a four-phase or more-phase converter.

### Another Embodiment 5

The above-described current control system 10 may be incorporated in a system other than the fuel cell system 100 to boost an output voltage of a power source other than the fuel cell 20. The above-describe current control system 10 may boost an output voltage of a secondary battery or a solar power generator, for example.
4. Others:

In the above-described embodiments, a part or all of the functions and processing achieved by software may be achieved by hardware. Moreover, a part or all of the functions and processing achieved by hardware may be achieved by software. As hardware, there may be used various kinds of circuits such as an integrated circuit, a discrete circuit, or a circuit module combining those circuits, for example.

The techniques of the disclosure are not limited to the above-described embodiments, examples, and modifications, and may be achieved by various configurations without departing from the scope of the disclosure. For example, the technical features in the embodiments, examples, and modifications corresponding to the technical features of each aspect in the summary of this specification may be appropriately replaced or combined in order to solve a part or all of the above-described problems or achieve a part or all of the above-described effects. In addition, it is possible to appropriately delete not only the technical features that are described as not necessary in the specification but also the technical features that are not described as necessary in the specification.

According to one aspect of this disclosure, there is provided a current control system. The current control system of this aspect includes a boost converter that includes a reactor and repeats one cycle of operation for accumulating and discharging electric energy into and from the reactor so as to boost an input voltage, and a converter controller that is configured to calculate a duty ratio defining a proportion of a period for inputting and accumulating the energy into the reactor in one cycle, so as to control boost operation of the boost converter using the duty ratio, the converter controller is configured to selectively perform control in a continuous mode using a duty ratio for the continuous mode in which a current larger than zero continuously flows in the reactor in one cycle or control in a discontinuous mode using a duty ratio for the discontinuous mode in which one cycle includes a period with a current output from the reactor being zero. The converter controller is configured to perform, at least in calculation of the duty ratio for the continuous mode, rising speed adjustment processing for adjusting a parameter used for the calculation of the duty ratio so that a rising amount of the duty ratio calculated in a current cycle is restricted relative to the duty ratio used in a last cycle in accordance with a predetermined limit value, so as to restrict a rising speed of the duty ratio for the continuous mode more than a rising speed of the duty ratio for the discontinuous mode.

In the current control system of the aspect, a rising speed that is a rising amount per unit time of the duty ratio for the continuous mode may be restricted more than a rising speed of the duty ratio for the discontinuous mode. Therefore, when the duty ratio for the continuous mode is selected, it is possible to prevent the abrupt increase of an output current. Moreover, it is possible to prevent the rising speed of the duty ratio for the discontinuous mode from being restricted greatly, which prevents the case in which a target increase amount of the output current is not obtained.

In the current control system according to the above-described aspect, the converter controller may be configured to perform the rising speed adjustment processing in calculation of the duty ratio for the continuous mode and calculation of the duty ratio for the discontinuous mode, and the limit value for calculating the duty ratio for the continuous mode is smaller than the limit value for calculating the duty ratio for the discontinuous mode.

In the current control system of this aspect, it is possible to restrict greatly, using different limit values, the rising speed of the duty ratio for the continuous mode more than the duty ratio for the discontinuous mode. Therefore, when the duty ratio for the continuous mode is selected, it is possible to prevent the abrupt increase of an output current. Moreover, it is possible to prevent the rising speed of the duty ratio for the discontinuous mode from being restricted greatly, which prevents the case in which a target increase amount of the output current is not obtained.

In the current control system of the above-described aspect, the converter controller may be configured to perform the rising speed adjustment processing only in calculation of the duty ratio for the continuous mode between calculation of the duty ratio for the continuous mode and calculation of the duty ratio for the discontinuous mode.

In the current system of this aspect, the rising speed of only the duty ratio for the continuous mode is restricted, which prevents the abrupt increase of an output current when the duty ratio for the continuous mode is selected. Moreover, the rising speed adjustment processing does not restrict a rising speed of the duty ratio for the discontinuous mode, which prevents a case in which a target increase amount of an output current is not obtained.

In the current control system of the above-described aspect, the parameter used for calculation of the duty ratio may be a feedforward term calculated using an input voltage and an output voltage of the boost converter, and the converter controller may be configured to calculate the feedforward term, adjust the feedforward term in the rising speed adjustment processing so that a difference between the duty ratio used in the last cycle and the feedforward term does not exceed the limit value, and calculate the duty ratio using the adjusted feedforward term.

In the current control system of the above-described aspect, the feed forward term is adjusted, which makes it possible to easily restrict a rising speed of the duty ratio for the continuous mode.

In the above-described current control system, in the rising speed adjustment processing, the converter controller may not change the feedforward term when the difference between the duty ratio used in the last cycle and the feedforward term is smaller than the limit value, and may set a value resulted by adding the limit value to the duty ratio used in the last cycle as the feedforward term when the difference between the duty ratio used in the last cycle and the feedforward term is larger than the limit value.

In the current control system of this aspect, the feedforward term may be set to the maximum in an allowed range, which prevent the case in which the duty ratio is set to be excessively small.

In the current control system of the above-described aspect, the converter controller may be configured to detect at least one of an output current and an output voltage of the boost converter, and add, after the rising speed adjustment processing, a feedback term in accordance with a deviation of the output current of the boost converter relative to a target output current to the adjusted feedforward term so as to calculate the duty ratio.

In the current control system of the above-described aspect, the feedback term is not restricted by a limit value, which makes it possible to allow the feedback term to compensate, with high accuracy, a deviation of the actual output current relative to the target output current in calculation of the duty ratio. This improves the accuracy of controlling an output current of the boost converter.

A second aspect is provided as a fuel cell system. A fuel cell system of this aspect includes a fuel cell, and a current control system according to any one of the above-described aspects that boosts an output voltage of the fuel cell and controls an output current of the fuel cell.

In the current control system of this aspect, it is possible to prevent an excessively large current occurred when the output voltage of the fuel cell is boosted.

The techniques of the disclosure may be also achieved by various aspects other than the current control system and the fuel cell system. For example, the techniques of the disclosure may be achieved by the aspects of a method of controlling a boost converter, a method of controlling a current control system, a method of controlling a fuel cell system, a method of controlling an output current of a fuel cell, a control device or a computer program achieving such control methods, a non-temporary recording medium recording such a computer program, a fuel cell vehicle, and the like.

What is claimed is:

1. A current control system, comprising:
a boost converter that includes a reactor and repeats one cycle of operation for accumulating and discharging electric energy into and from the reactor so as to boost an input voltage; and
a converter controller that is configured to calculate a duty ratio defining a proportion of a period for inputting and accumulating the energy into the reactor in one cycle, so as to control boost operation of the boost converter using the duty ratio, the converter controller is configured to selectively perform control in a continuous mode using, as the duty ratio, a duty ratio for the continuous mode in which a current larger than zero continuously flows in the reactor in one cycle or control in a discontinuous mode using, as the duty ratio, a duty ratio for the discontinuous mode in which one cycle includes a period with a current output from the reactor being zero, wherein
the converter controller is configured to perform, at least in calculation of the duty ratio for the continuous mode, rising speed adjustment processing for adjusting a parameter used for the calculation of the duty ratio so that a rising amount of the duty ratio calculated in a current cycle is restricted relative to the duty ratio used in a last cycle in accordance with a predetermined limit value, so as to restrict a rising speed of the duty ratio for the continuous mode more than a rising speed of the duty ratio for the discontinuous mode.

2. The current control system according to claim 1, wherein
the converter controller is configured to perform the rising speed adjustment processing in calculation of the duty ratio for the continuous mode and calculation of the duty ratio for the discontinuous mode, and the limit value for calculating the duty ratio for the continuous mode is smaller than the limit value for calculating the duty ratio for the discontinuous mode.

3. The current control system according to claim 1, wherein
the converter controller is configured to perform the rising speed adjustment processing only in calculation of the duty ratio for the continuous mode between calculation of the duty ratio for the continuous mode and calculation of the duty ratio for the discontinuous mode.

4. The current control system according to claim 1, wherein
the parameter used for calculation of the duty ratio is a feedforward term calculated using an input voltage and an output voltage of the boost converter, and
the converter controller is configured to calculate the feedforward term, adjust the feedforward term in the rising speed adjustment processing so that a difference between the duty ratio used in the last cycle and the feedforward term does not exceed the limit value, and calculates the duty ratio using the adjusted feedforward term.

5. The current control system according to claim 4, wherein
in the rising speed adjustment processing, the converter controller does not change the feedforward term when the difference between the duty ratio used in the last cycle and the feedforward term is smaller than the limit value, and sets a value resulted by adding the limit value to the duty ratio used in the last cycle as the feedforward term when the difference between the duty ratio used in the last cycle and the feedforward term is larger than the limit value.

6. The current control system according to claim 4, wherein
the converter controller is configured to detect at least one of an output current and an output voltage of the boost converter, and add, after the rising speed adjustment processing, a feedback term in accordance with a deviation of the output current of the boost converter relative to a target output current to the adjusted feedforward term so as to calculate the duty ratio.

7. A fuel cell system, comprising:
a fuel cell; and
a current control system according to claim 1 that boosts an output voltage of the fuel cell and controls an output current of the fuel cell.

8. A method of controlling a boost converter that includes a reactor and repeats one cycle of operation for accumulating and discharging electric energy into and from the reactor so as to boost an input voltage, using a duty ratio defining a proportion of a period for inputting and accumulating the energy into the reactor in the one cycle, the control method comprising:
selectively performing control in a continuous mode using, as the duty ratio, a calculated duty ratio for the continuous mode in which a current larger than zero continuously flows in the reactor in the one cycle or control in a discontinuous mode using, as the duty ratio, a calculated duty ratio for the discontinuous mode in which the one cycle includes a period with a current output from the reactor being zero; and
performing, at least in calculation of the duty ratio for the continuous mode, rising speed adjustment processing for adjusting a parameter used for the calculation of the duty ratio so that a rising amount of the duty ratio calculated in a current cycle is restricted relative to the duty ratio used in a last cycle in accordance with a predetermined limit value, so as to restrict a rising speed of the duty ratio for the continuous mode more than a rising speed of the duty ratio for the discontinuous mode.
